(19) United States
(12) Patent Application Publication
(10) Pub. No.: US 2026/0079632 A1
(43) Pub. Date: Mar. 19, 2026

(54) INTEGRATED CIRCUIT

(71) Applicant: Infineon Technologies AG, Neubiberg (DE)

(72) Inventors: Thomas Röcker, München (DE); Uwe Moslehner, Geiselbach (DE); Georg Schmalz, Nackenheim (DE); Kai Dieffenbach, Egelsbach (DE); Richard Landenbach, Langen (DE)

(21) Appl. No.: 19/324,364

(22) Filed: Sep. 10, 2025

(30) Foreign Application Priority Data
Sep. 19, 2024 (DE) 102024126952.9

(51) Int. Cl. G06F 3/06

(52) U.S. Cl. CPC G06F 3/0622; G06F 3/0637; G06F 3/0673

(57) ABSTRACT

According to one embodiment, what is described is an integrated circuit, including multiple system components that include multiple master units and multiple slave units. Each slave unit is configured to allow each of the multiple master units access to one or more functions of the slave unit depending on which identification, from a predefined set of identifications, the master unit communicates to the slave unit. The integrated circuit includes a writable configuration memory that stores, for each of the master units and each identification, whether the master unit is permitted to communicate the identification to the slave units, and an identification control device that is configured to restrict the identification communicated by the master unit for accessing the respective slave unit to identifications for which the configuration memory indicates that the master unit is permitted to communicate the identification to the slave units.

### REFERENCE TO RELATED APPLICATION

This Application claims priority to German Application number 102024126952.9, Sep. 19, 2024, the contents of which are hereby incorporated by reference in their entirety.

### TECHNICAL FIELD

Exemplary embodiments relate in general to integrated circuits.

### BACKGROUND

The increasing complexity and integration density of data processing devices is leading to the need to logically partition the respective system implemented or to separate or isolate resources from one another. One example of this is the integration of different applications in a system (for example a system-on-chip, SoC), these applications having different integrity levels, which leads to access operations to different resources, such as for example memory areas, having to be regulated in order to prevent for example a program that is not particularly trustworthy, that is to say for example a non-secure processor, from being able to access security-critical data, such as for example cryptographic keys. It would therefore be desirable to have effective and efficient mechanisms for regulating access of processors (generally master units) to other system components (generally slave units) of an integrated circuit.

### SUMMARY

According to one embodiment, provision is made for an integrated circuit, comprising multiple system components, wherein the multiple system components comprise multiple master units and multiple slave units, wherein each slave unit is configured to allow each of the multiple master units access to one or more functions of the slave unit depending on which identification, from a predefined set of identifications, the master unit communicates to the slave unit, a writable configuration memory that stores, for each of the master units and each identification of the set of identifications, whether it is permitted to communicate the identification to the slave units when it wishes to access them, and an identification control device that is configured, for each master unit and for each operation of the master unit accessing any of the slave units, to restrict the identification communicated by the master unit for accessing the respective slave unit to identifications for which the configuration memory stores the fact that it is permitted to communicate said identification to the slave units.

### BRIEF DESCRIPTION OF THE DRAWINGS

The figures do not reproduce the actual size relationships, but rather are intended to serve to illustrate the principles of the various exemplary embodiments. Various exemplary embodiments are described below with reference to the following figures.

FIG. 1 shows an integrated circuit according to one embodiment.

FIG. 2 illustrates a processor accessing a system component.

FIG. 3 illustrates a configuration memory according to one embodiment.

FIG. 4 illustrates the definition of permissible identifications for processors for different operating modes.

### DESCRIPTION

The following detailed description refers to the accompanying figures, which show details and exemplary embodiments. These exemplary embodiments are described in such detail that a person skilled in the art is able to carry out the invention. Other embodiments are also possible and the exemplary embodiments may be changed in structural, logical and electrical terms without departing from the subject matter of the invention. The various exemplary embodiments are not necessarily mutually exclusive; rather, various embodiments may be combined with one another to produce new embodiments. Within the scope of this description, the terms “connected” and “coupled” are used to describe both a direct and an indirect connection and direct or indirect coupling.

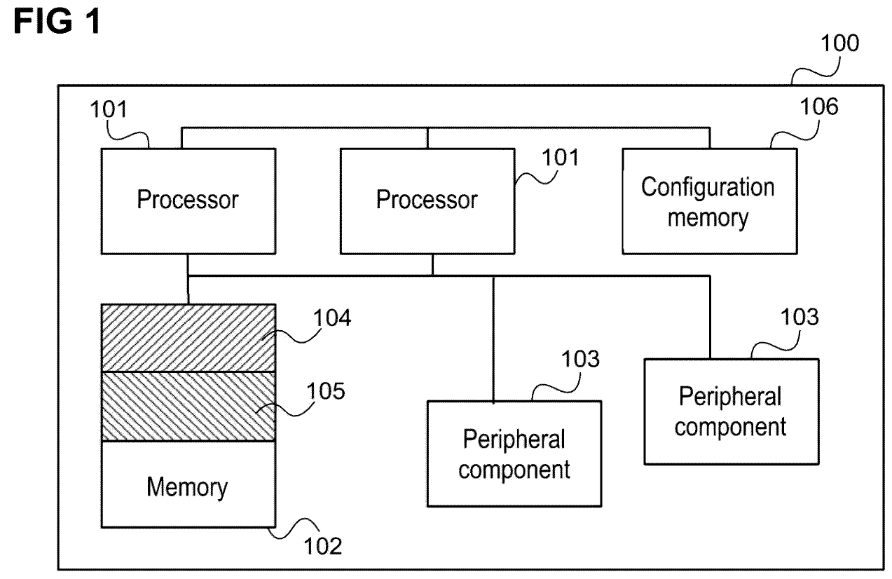

FIG. 1 shows an integrated circuit 100 according to one embodiment.

The integrated circuit 100, for example a microcontroller, for example in a vehicle, forms a system-on-chip (SoC), for example.

The integrated circuit comprises multiple processors (central processing units, CPUs) 101 (for example RISC-V CPUs) and also multiple other system components 102, 103, such as for example memories 102 and peripheral components 103 that the processors are able to access. The processors 101 may accordingly be considered to be master components, and the other system components 102, 103 may be considered to be examples of slave units. The processors may likewise be considered to be examples of master units. By way of example, these master units may also be DMA controllers, hardware threads (HARTs), virtual processors (virtual machines) or other components that access other components.

The processors 101 may run various programs. These programs may have different integrity levels (that is to say they may in particular be trusted to varying degrees), and they may have different security requirements, that is to say different criticalities, which stem for example from the respective industrial context in which they are used, such as for example ASIL (Automotive Safety Integrity Level), CAL (Cybersecurity Assurance Level), EAL (Evaluation Assurance Level), SIL (Safety Integrity Level), etc. The processors may also have different inherent trust levels (or integrity levels). By way of example, one processor is the processor of a hardware security module (HSM), and is therefore very trustworthy (for example a hardware root-of-trust), while another processor is a coprocessor (for example a graphics processing unit, GPU) that cannot be particularly trusted. These trust levels may also differ for the same operating mode. By way of example, two processors 101 may have different trust levels, even if they are both in machine mode (M mode).

The processors 101 thus have different trust levels either inherently or due to the software they run, and should therefore also have different privileges. By way of example, only a processor 101 with a high trust level should be able to access a first memory area 104 of the memory 102 storing security-critical data, whereas a processor with a low trust level is also permitted to access a second memory area 105 not storing any security-critical data. The same applies to peripheral components, such as for example memory interfaces to chip-external memories, network interfaces, interfaces to actuators (such as for example in a vehicle), etc.

To achieve this, there is a need for a mechanism that filters operations of master components (processors 101) accessing slave components (memories 102 and peripherals 103), that is to say for example prevents master components with a low integrity level from accessing security-critical resources (such as memory areas). In the case of a high number of master components (such as for example a chip with 32 processors), it should also be possible here to group processors with the same integrity level in order to keep the number of different access rights and thus the number of bits required to specify them (and thus ultimately the chip surface required to implement such a mechanism) as low as possible.

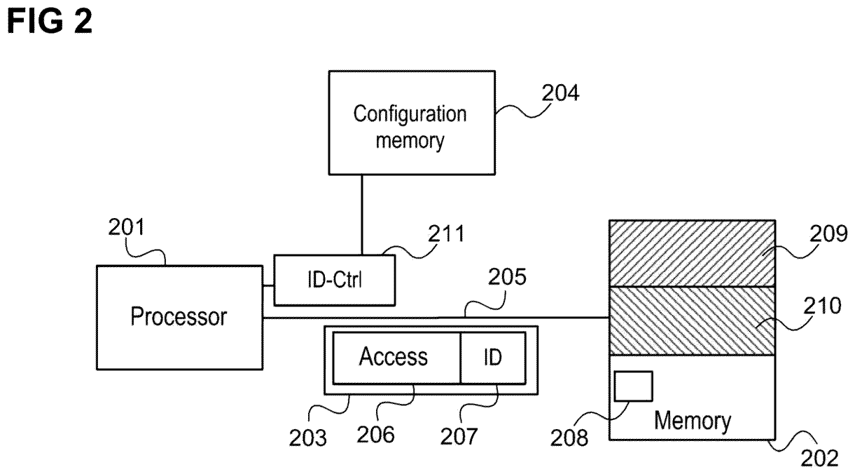

According to various embodiments, provision is made for a configuration memory 106 in order to provide such a mechanism. This defines which identifications are permitted to be used by processors (generally master units) 101 in access messages, that is to say messages for accessing the other system components (generally slave units) 102, 103. This is explained below with reference to FIG. 2.

FIG. 2 illustrates a processor 201 (corresponding for example to one of the processors 101) accessing a system component 202 (corresponding for example to one of the other system components 102, 103).

To access the system component 202, the processor 201 sends an access message 203 to the system component 202 via a connection 205, for example a bus.

The access message 203 contains a specification 206 of the access (for example read access to a particular memory address) and contains an identification 207 from a predefined (overall) set of identifications, that is to say the processor 201 inserts one of the identifications from the set of identifications into the access message 203.

The system component 202 contains an access rights memory 208 from the content of which (for example an access rights table) it is apparent, for each identification from the set of identifications, which access rights are linked to this identification. By way of example, the system component 202 is a memory having a first memory area 209 and a second memory area 210, and processors that identify themselves by way of the identifications WID0 (WID for “world identification”, that is to say the identification of a “world” or an access domain to which the respective processor belongs or in which it acts) and WID1 (that is to say send these as an identification 207 in the respective access message 203) have access rights to the first memory area 209 and the second memory area 210, whereas processors that identify themselves by way of the identifications WID2, WID3 and WID4 are able to access only the second memory area 210 (that is to say the system component 202 in this case allows only access to the second memory area 210, that is to say does not provide access to the first memory area 209, which is specified in the respective access message 203 but contains WID2, WID3 or WID4 as identification). Generally speaking, the memory areas 209, 210 correspond to certain functions, for example if the system component 202 is an interface, communication with a specific component, etc.

Each function (for example each memory area, that is to say access to a particular memory area) belongs to a specific “world”, that is to say, in other words, to an access domain, and each of these access domains corresponds to a respective identification of the predefined set of identifications (one-to-one, that is to say each access domain is assigned exactly one identification of the predefined set of identifications and different access domains are assigned different identifications, wherein the access domains may however overlap, or one may even contain another). An access domain, illustratively speaking, defines a set of functions belonging to the same access rights level. By way of example, the access domain of WID0 incorporates the first memory area 209 and the second memory area 210, whereas the access domain of WID2 for example contains only the second memory area 210. The access domain to which a particular function of a system component 202 belongs is defined by the content of the access rights memory 208, as described above.

In order that the processor 201 does not simply use an identification 207 linked to access rights by the content of the access rights memory 208 (for example an access rights table), the processor 201 not being permitted to have these access rights, provision is made for an identification control device 211 (for example a corresponding hardware circuit) that restricts for example which identifications the processor 201 is permitted to insert into the access message 203 as an identification 207, that is to say the set of identifications from which the processor 201 is permitted to select. This identification set authorized for the processor 201 is a (possibly real) subset of the predefined set of identifications.

The identification set authorized for the processor 201 is defined in the configuration memory 106 (configuration memory 204 in FIG. 2), which is designed for example as follows.

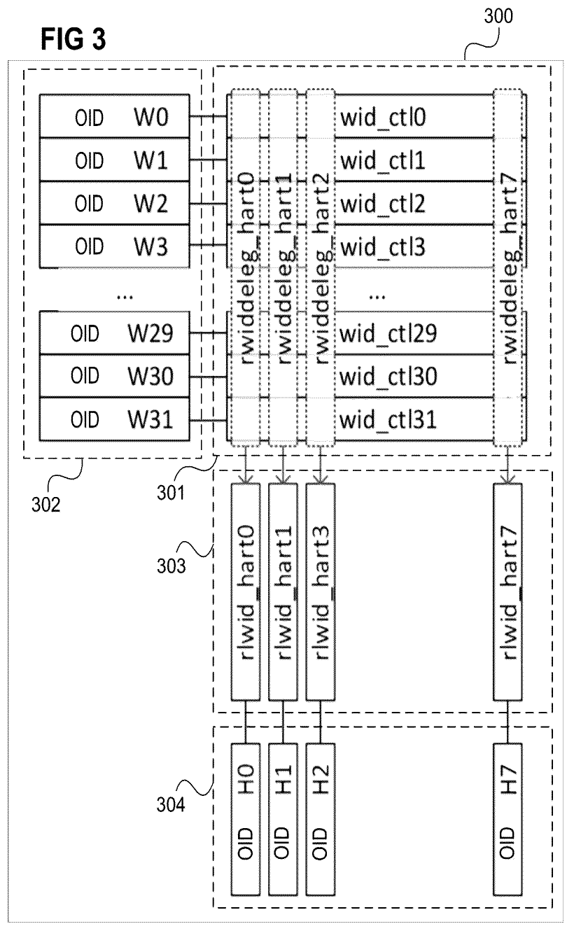

FIG. 3 illustrates a configuration memory 300 according to one embodiment.

In this example, the configuration memory 300 has a matrix form: It has, in a first configuration memory area 301, one row for each security area (here W0 to W31) and one column for each processor. Each entry (for example stored by a memory cell, such as for example a respective flip-flop) defines whether the respective processor is permitted (for example by an entry equal to 1) or not permitted (for example by an entry equal to 0) to use the identification assigned to the respective security area (that is to say the respective “world”), that is to say permitted to use it as an identification 207 in an access message 203. If it is not permitted to use an identification 207, the identification control device 211 prevents it from using said identification. The matrix (or each row thereof) may be considered to be a mask for the identifications, wherein identifications are masked out of the predefined overall set of identifications for each processor (for example by zeros in the matrix), and the processor is permitted to use only the remaining identifications.

The configuration memory 300 therefore contains, for each access domain, a register (in the form of a row) that defines which processor has access rights for the access domain (since it may be permitted to use the respective identifications). In other words, the configuration memory 300 contains, for each processor, a register (in the form of a column) that defines the access domains to which the processor has access rights.

In this example, the configuration memory 300, in a second configuration memory area 302, contains an identification of the “owner” (here OID for “owner ID”) of the respective security area for each row. Provision may also be made for the owner of a row to configure the row, and the owner then changes. The current owner is thus always permitted to configure the row (including OID).

By way of example, the configuration memory 300 also contains a third memory area 303 that specifies, for each processor, the identification that the processor uses in its highest privilege level (for example M mode) in access messages. By way of example, this ID for M mode of the respective processor is allocated by root software (which may run on the same processor or else on other processors in the system). The reason for the third memory area 303 is that the ID of M mode of the processors is to be specified “externally” by the root software. It is normally software of another processor that defines the ID for M mode before the corresponding processor boots. In the special case of a boot processor (that is to say the root of trust), the ID may be determined by a reset value. A processor finding its own ID for M mode is thus ruled out. The ID for M mode is also restricted to the IDs that are identified in the column of the memory area 301 as being IDs that this master unit is permitted to use.

The identification permitted to be configured by the ID for M mode of the processor, that is to say the owner identification (OID) of the third memory area 303, is stored for example in a fourth configuration memory area 304 in the form of, for each column, an assignment of OID to an identification of the respective processor (here hart0 to hart7 or else H0 to H7). This is relevant for write access operations to configuration memory areas 303 and 304 (which identifications have the right to write access operations to the configuration memory areas 301 and 302 is regulated by the second configuration memory area 302). In other words: The fourth configuration memory area 304 regulates who is permitted to write to the third configuration memory area 303 (that is to say which identification must be used to write to the third configuration memory area 303) and the content of the first configuration memory area 301 (depending on the column) regulates what is permitted to be written to the third configuration memory area 303.

The content of the configuration memory 300 is written for example each time the integrated circuit 100 is booted (for example from one or more of the processors 101) and is then static (that is to say “locked”) for the duration of operation of the integrated circuit 100 (until the next boot). However, provision may also be made for the possibility of dynamic reconfiguration. By way of example, it may thus be possible to add ‘1’s in the matrix at any time (that is to say a “world” may be expanded to allow another processor to participate as needed), and it may also be possible, for example for the owner of the respective row, to remove ‘1’s. A row may be “locked” by the owner of the corresponding WID being set to an owner that is not present in the system.

By way of example, the writing is carried out in a certain order (according to a prioritization) of the processors 101, for example an HSM starts writing, followed by a relatively trustworthy processor, followed by a less trustworthy processor, etc. A processor is not permitted here to change the configuration carried out by a processor that precedes it in the order (that is to say write to the configuration memory 300). It may also be possible for a “root authority”, for example an HSM, to write to the configuration memory 300 in full.

A processor 101 may also implement one or more virtual processors. Provision may then be made for permissible identifications not to be defined for each virtual processor, but rather for the permissible identifications of a processor to be divided (for example by the hypervisor) between the virtual processors implemented by the processor.

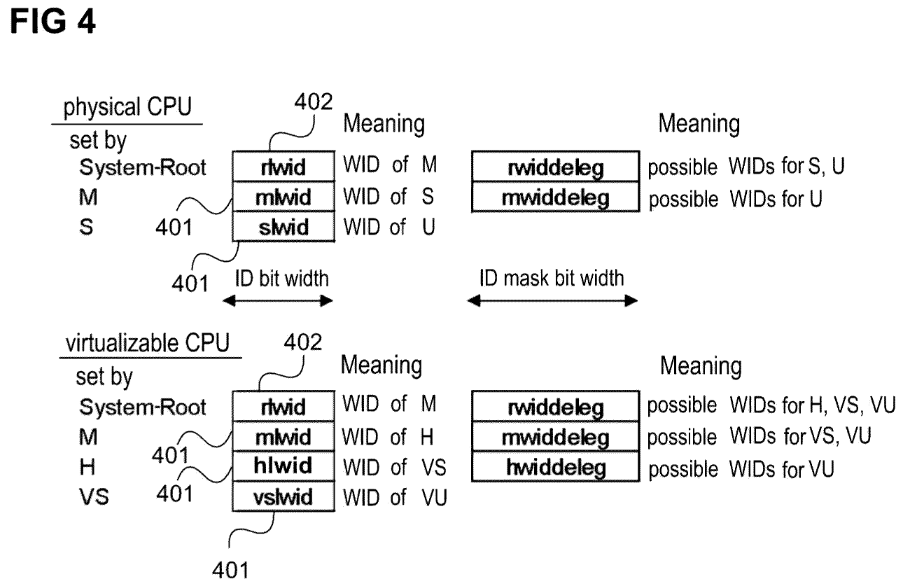

The identifications that a processor 101 is permitted to use may also be defined for each operating mode, as illustrated in FIG. 4.

FIG. 4 illustrates the definition of permissible identifications for processors for different operating modes.

By way of example, a processor 101 uses the identification “rlwid” in M mode, “mlwid” in S mode and “slwid” in U mode, the designations being derived from the operating mode in which they are defined (by the processor having the respective mode): “rlwid”in root mode, “mlwid”in M mode and “slwid”in S mode.

By way of example, a virtualizable processor (which may implement multiple virtual processors (or virtual machines)), instead of S mode and U mode, has an H mode, a VS mode and a VU mode, and accordingly identifications therefor: “mlwid” for H (hypervisor) mode (defined by the processor in M mode), “hlwid” for VS mode (defined by the processor in H mode), and “vslwid” for VU mode (defined by the processor in VS mode).

According to various embodiments, one or more usable identifications are thus assigned to the next-lowest level in each mode (integrity level). The identification for M mode and a mask for the lower trust levels (rwiddeleg) are defined in the configuration memory 300. Further masks for lower trust levels further below may also be defined locally (that is to say by the processor in a higher trust level) (mwiddeleg in FIG. 4), these then further restricting the identifications able to be used thereby.

By way of example, the processor stores the identifications that it uses (that is to say has selected) in the various operating modes in local (that is to say processor-internal) registers 401, that is to say one register stores “mlwid”, another stores “slwid”, etc., wherein “rlwid” is stored only in the configuration memory, as described with reference to FIG. 3 (illustrated in FIG. 4 by processor-external registers 402, that is to say, illustratively speaking, on the system (for example SoC) level and not on the master unit level).

The identification control device 211 checks that the identifications defined for the various operating modes are within the (sub)set of identifications that the processor is permitted to use (that is to say the possible or permissible identifications) as defined in the configuration memory 106, 204, or checks at least that the processor does not use any identifications that it is not permitted to use as an identification 207 in an access message 203.

According to the various operating modes, according to one embodiment, the respective (sub)sets of identifications that the processors are permitted to use are passed on by modes on higher integrity levels to lower integrity levels, that is to say delegated downwards, wherein for example the identifications are restricted increasingly (like by way of the mask mwiddeleg in FIG. 4, which further restricts the externally specified mask rwiddeleg).

If no delegation mechanism is provided, the configuration memory 300 may, in one embodiment, separately specify the respective (sub)sets of identifications that the processors are permitted to use, including for different operating modes and/or virtual processors (virtual machines). In the example of FIG. 3, for example, the first configuration memory area 301 of the configuration memory 300 specifies the identifications from which a particular processor is permitted to select for S mode and U mode (or H, VS, VU mode in the case of a virtualizable processor). For other operating modes, the configuration memory 300 then comprises for example further versions of the first configuration memory area 301:
a further version that specifies the identifications from which the processor is permitted to select for U mode (or VS, VU mode in the case of a virtualizable processor)
a further version that specifies the identifications from which a virtualizable processor is permitted to select for VU mode

By way of example, as explained above, the trust levels of the individual processors 101 stem from which software they are running (since the software has different trust levels). A separation of the processors 101 with regard to their access rights thus also corresponds to a logical separation of different software components. According to various embodiments, provision is made here for trustworthy processors (or trustworthy software components) to be able to limit the access rights for less trustworthy processors (or less trustworthy software components), for example by virtue of a processor first launching a trustworthy program that writes to the configuration memory 106 at least partially and defines that for example only it (or one or more equally trustworthy processors) has certain access rights (for example to a protected memory area). Although software components that are launched subsequently may then possibly also write to the configuration memory 106, they cannot circumvent this limitation. This enables for example a flexible yet secure boot process in which software components are loaded successively (for example if required) and are able to configure their access rights, and in particular in the process restrict the access rights of software components that are launched later.

According to various embodiments, the access rights are defined globally in the sense that the configuration memory (which is external with respect to the processors) provides the identifications able to be used by the processors (and thus their access rights).

In summary, according to various embodiments, provision is made for an integrated circuit (see FIG. 1 and FIG. 2), comprising
multiple system components, wherein the multiple system components comprise multiple master units (DMA controllers, processors, virtual machines, HARTs, etc.) and multiple slave units (peripheral components or memories), wherein each slave unit is configured to allow each of the multiple master units access to one or more functions of the slave unit depending on which identification, from a predefined (global, that is to say known to all of the system components) set of identifications, the master unit (carrying out the respective access operation) communicates to the slave unit,
a writable configuration memory that stores, for each of the master units and each identification of the set of identifications, whether it is permitted to communicate the identification to the slave units when it wishes to access them, and
an identification control device that is configured, for each master unit and for each operation of the master unit accessing any of the slave units, to restrict the identification communicated by the master unit for accessing the respective slave unit to identifications for which the configuration memory stores the fact that it is permitted to communicate said identification to the slave units (that is to say the identification control device masks for example identifications that are not allowed).

According to various embodiments, provision is made, in an integrated circuit, for a circuit block that stores, for all identifications, a global set of identifications as to which of multiple master units (for example processors in the above exemplary embodiments) are permitted to use them, wherein each identification is assigned an access domain, that is to say one or more access rights are assigned to each of the other access components.

By way of example, the configuration memory is a central memory of the integrated circuit. It is for example in particular not a distributed memory, which is expressed for example in that it is formed by memory cells of a contiguous set of memory addresses. It jointly stores the access rights for the multiple master units as described above, that is to say whether the master units are permitted to communicate the respective identification to the slave units when they wish to access them. The configuration memory stores these access rights across the system, that is to say for all of the multiple master units. According to various embodiments, the configuration memory is external to and superordinate to the master units, that is to say it defines the “maximum” access rights for them (that is to say the identifications from which they are able to select). The configuration memory stores the permissible identifications for each world ID (that is to say separated by world IDs), for example as described above.

The integrated circuit may also comprise master units other than the “multiple master units” (for which configuration memories store the access rights in the manner described above).

As described above, the configuration memory may have the form of a matrix in which the registers are the rows from a software point of view, and each row also has a separate owner, but the rwiddeleg registers relevant for the master units (for example CPUs) are the columns, that is to say a rwiddeleg consists of n (here for example 32) bits, which come from different registers with (possibly) different owners. This enables an incremental rollout that would not be possible if every rwiddeleg register had an owner. The memory elements in the matrix are arranged in rows (one row per identification) from a software point of view (and from an owner assignment point of view), but the hardware (that is to say interface to the identification control devices) extracts the information about the permissible identifications that apply to the master units column by column. This is a translation from the logical to the physical aspect, and this translation ultimately enables the incremental rollout, that is to say the owner of a first identification WID1 may unalterably define, at a first time, which of the master units is permitted to use the first identification WID1, and the owner of a second identification WID2 may unalterably define, at a second time, which of the master units is permitted to use the second identification WID2.

In the case of this writing to the configuration memory in a predefined order of the master units,
1. the configuration memory may be defined permanently for all processors for each identification, that is to say the writing may be permanent for each boot of the integrated circuit (static case) or
2. the configuration memory may initially be filled for some or all identifications, and modified cooperatively at runtime (dynamic case).

Various exemplary embodiments are specified below.

Exemplary embodiment 1 is an integrated circuit, comprising multiple system components, wherein the multiple system components comprise multiple master units and multiple slave units, wherein each slave unit is configured to allow each of the multiple master units access to one or more functions of the slave unit depending on which identification, from a predefined set of identifications, the master unit communicates to the slave unit, a writable configuration memory that stores, for each of the master units and each identification of the set of identifications, whether it is permitted to communicate the identification to the slave units when it wishes to access them, and an identification control device that is configured, for each master unit and for each operation of the master unit accessing any of the slave units, to restrict the identification communicated by the master unit for accessing the respective slave unit to identifications for which the configuration memory stores the fact that it is permitted to communicate said identification to the slave units.

Exemplary embodiment 2 is an integrated circuit according to exemplary embodiment 1, wherein the multiple slave units comprise at least one memory and/or at least one peripheral component.

Exemplary embodiment 3 is an integrated circuit according to exemplary embodiment 1 or 2, wherein at least one of the multiple slave units is a memory comprising multiple memory areas and the one or more functions of the memory to which the memory allows access depending on which identification from the set of identifications the master unit carrying out the respective access operation communicates thereto comprise memory access operations, wherein each of the memory access operations is an access operation to a respective memory area of the multiple memory areas.

Exemplary embodiment 4 is an integrated circuit according to one of exemplary embodiments 1 to 3, wherein the master unit communicates the identification from the set of identifications to the slave unit in an access message.

Exemplary embodiment 5 is an integrated circuit according to one of exemplary embodiments 1 to 4, wherein, for each slave unit, the identification depending on which the slave unit allows a master unit access to one of its functions is an identification that the master unit inserts into an access message that it sends to the slave unit.

Exemplary embodiment 6 is an integrated circuit according to exemplary embodiment 5, wherein the master unit specifies the access in the access message.

Exemplary embodiment 7 is an integrated circuit according to one of exemplary embodiments 1 to 6, wherein each slave unit comprises an access rights memory that stores, for each of the one or more functions of the slave unit, the identification or identifications that any of the master units communicates to the slave unit for which the slave unit allows the master unit access to the function.

Exemplary embodiment 8 is an integrated circuit according to one of exemplary embodiments 1 to 7, wherein the configuration memory comprises a matrix consisting of memory elements, wherein each memory element is assigned to a respective pair consisting of one of the master units and one of the identifications of the set of identifications and stores whether the master unit of the pair is permitted to communicate the identification of the pair to one of the slave units when it wishes to access the slave unit.

Exemplary embodiment 9 is an integrated circuit according to one of exemplary embodiments 1 to 8, wherein the configuration memory is external to the multiple master units.

Exemplary embodiment 10 is an integrated circuit according to one of exemplary embodiments 1 to 9, wherein at least one of the master units is configured to write, to the configuration memory for at least some of the master units and at least part of the set of identifications to the configuration memory, whether the master units are permitted to communicate the identifications to the slave units when they wish to access them.

Exemplary embodiment 11 is an integrated circuit according to exemplary embodiment 10, wherein the at least one master unit is a hardware security module and/or a hardware root-of-trust.

Exemplary embodiment 12 is an integrated circuit according to one of exemplary embodiments 1 to 9, wherein a plurality of the master units are configured to write, successively in a predefined order, to the configuration memory in each case for at least a respective portion of the master units and at least a respective portion of the set of identifications to the configuration memory, whether the master units are permitted to communicate the identifications to the slave units when they wish to access them.

Exemplary embodiment 13 is an integrated circuit according to exemplary embodiment 12, wherein the order is an order in which the master units start operating when the integrated circuit is booted.

Exemplary embodiment 14 is an integrated circuit according to one of exemplary embodiments 1 to 13, wherein, for each identification of the set of identifications, at least one of the identifications is defined as the owner of the identification, and out of the master units, only a master unit that is permitted to use the at least one identification is permitted to write the entries to the configuration memory specifying which of the master units is permitted to communicate the identification of the set of identifications to the slave units.

Exemplary embodiment 15 is an integrated circuit according to one of exemplary embodiments 1 to 14, wherein the configuration memory stores, for each of the master units and each identification of the set of identifications, whether it is permitted to communicate the identification to the slave units when it wishes to access them, for each operating mode of multiple operating modes of the master unit, and the identification control device is configured, for each master unit and for each operating mode of the master unit, for each operation of the master unit accessing any of the slave units in the operating mode, to restrict the identification communicated by the master unit for accessing the respective slave unit to identifications for which the configuration memory stores the fact that it is permitted to communicate said identification to the slave units in the operating mode.

Although the invention has been shown and described primarily with reference to specific embodiments, it should be understood by those familiar with the technical field that numerous modifications may be made thereto with regard to configuration and details, without departing from the essence and scope of the invention as defined by the claims hereinafter. The scope of the invention is therefore determined by the appended claims, and the intention is for all modifications that come under the literal meaning or the scope of equivalence of the claims to be encompassed.

### REFERENCE SIGNS

100 Integrated circuit
101 Processors
102 Memories
103 Peripheral components
104, 105 Memory areas
106 Configuration memory
201 Processor
202 System component
203 Access message
204 Configuration memory
205 Connection
206 Access specification
207 Identification
208 Access rights memory
209, 210 Memory areas
211 Identification control device
300 Configuration memory
301-304 Configuration memory areas
401 Internal processor registers
402 Processor-external registers

What is claimed is:

1. An integrated circuit, comprising:
multiple system components, wherein the multiple system components comprise multiple master units and multiple slave units, wherein each slave unit is configured to allow each of the multiple master units access to one or more functions of the slave unit depending on which identification, from a set of identifications, the master unit communicates to the slave unit;
a writable configuration memory that stores, for each of the master units and each identification of the set of identifications, whether it is permitted to communicate the identification to the slave units; and
an identification control device that is configured, for each master unit and for each access operation of the master unit accessing any of the slave units, to restrict the identification communicated by the master unit for accessing the respective slave unit to identifications for which the configuration memory indicates that the master unit is permitted to communicate said identification to the slave units.

2. The integrated circuit of claim 1, wherein the multiple slave units comprise at least one memory and/or at least one peripheral component.

3. The integrated circuit of claim 1, wherein at least one of the multiple slave units is a memory comprising multiple memory areas and the one or more functions of the memory to which the memory allows access depending on which identification from the set of identifications the master unit carrying out the respective access operation communicates thereto comprise memory access operations, wherein each of the memory access operations is an access operation to a respective memory area of the multiple memory areas.

4. The integrated circuit of claim 1, wherein the master unit communicates the identification from the set of identifications to the slave unit in an access message.

5. The integrated circuit of claim 1, wherein, for each slave unit, the identification depending on which the slave unit allows a master unit access to one of its functions is an identification that the master unit inserts into an access message that it sends to the slave unit.

6. The integrated circuit of claim 5, wherein the master unit specifies the access in the access message.

7. The integrated circuit of claim 1, wherein each slave unit comprises an access rights memory that stores, for each of the one or more functions of the slave unit, the identification or identifications that any of the master units communicates to the slave unit for which the slave unit allows the master unit access to the function.

8. The integrated circuit of claim 1, wherein the configuration memory comprises a matrix consisting of memory elements, wherein each memory element is assigned to a respective pair consisting of one of the master units and one of the identifications of the set of identifications and stores whether the master unit of the pair is permitted to communicate the identification of the pair to one of the slave units.

9. The integrated circuit of claim 1, wherein the configuration memory is external to the multiple master units.

10. The integrated circuit of claim 1, wherein at least one of the master units is configured to write, to the configuration memory for at least some of the master units and at least part of the set of identifications to the configuration memory, whether the master units are permitted to communicate the identifications to the slave units.

11. The integrated circuit of claim 10, wherein the at least one master unit is a hardware security module and/or a hardware root-of-trust.

12. The integrated circuit of claim 1, wherein a plurality of the master units are configured to write, successively in a predefined order, to the configuration memory in each case for at least a respective portion of the master units and at least a respective portion of the set of identifications to the configuration memory, whether the master units are permitted to communicate the identifications to the slave units.

13. The integrated circuit of claim 12, wherein the order is an order in which the master units start operating when the integrated circuit is booted.

14. The integrated circuit of claim 12, wherein, for each identification of the set of identifications, at least one of the identifications is defined as an owner of the identification, and out of the master units, only a master unit that is permitted to use the at least one identification is permitted to write to the configuration memory specifying which of the master units is permitted to communicate the identification of the set of identifications to the slave units.

15. The integrated circuit of claim 1, wherein the configuration memory stores, for each of the master units and each identification of the set of identifications, whether it is permitted to communicate the identification to the slave units, for each operating mode of multiple operating modes of the master unit, and the identification control device is configured, for each master unit and for each operating mode of the master unit, for each operation of the master unit accessing any of the slave units in the operating mode, to restrict the identification communicated by the master unit for accessing the respective slave unit to identifications for which the configuration memory stores the indication of whether the master unit is permitted to communicate said identification to the slave units in the operating mode.

16. An access control system, comprising
a writable configuration memory configured to store one or more master identifications and, for each master unit, an indication of whether the master unit is permitted to use the master identification when communicating with a particular slave unit; and
an identification control device configured to control access to slave units by the master unit based on the writable configuration memory.

17. The access control system of claim 16, wherein
the master unit appends a master identification to each access message directed to a slave unit; and
the access control unit is configured to prevent the master unit from appending a master identification to an access message when the writable configuration memory indicates that the master unit is not permitted to use the master identification when communicating with the slave unit.

18. The access control system of claim 16, wherein the configuration memory comprises a matrix consisting of memory elements, wherein each memory element is assigned to a respective pair consisting of one of the master units and one of the master identifications and stores an indication of whether the master unit of the pair is permitted to communicate the identification of the pair to one of the slave units.

19. The access control system of claim 16, wherein the writable configuration memory is configured to store one or more indications of whether the master units are permitted to communicate the master identifications to the slave units.

20. The access control system of claim 16, wherein the writable configuration memory is external to the master unit.
